(19) United States
(12) Patent Application Publication
(10) Pub. No.: US 2013/0201210 A1
(43) Pub. Date: Aug. 8, 2013

(54) VIRTUAL RULER

(71) Applicants: Sundeep Vaddadi, San Diego, CA (US); Krishnakanth S. Chimalamarri, Atlanta, GA (US); John H. Hong, San Clemente, CA (US); Chong U. Lee, San Diego, CA (US)

(72) Inventors: Sundeep Vaddadi, San Diego, CA (US); Krishnakanth S. Chimalamarri, Atlanta, GA (US); John H. Hong, San Clemente, CA (US); Chong U. Lee, San Diego, CA (US)

(73) Assignee: QUALCOMM Incorporated, San Diego, CA (US)

(21) Appl. No.: 13/563,330

(22) Filed: Jul. 31, 2012

Related U.S. Application Data
(60) Provisional application No. 61/586,228, filed on Jan. 13, 2012.

(51) Int. Cl. G06T 19/00

(52) U.S. Cl. CPC G06T 19/006
USPC 345/632

(57) ABSTRACT

In some embodiments, first information indicative of an image of a scene is accessed. One or more reference features are detected, the reference features being associated with a reference object in the image. A transformation between an image space and a real-world space is determined based on the first information. Second information indicative of input from a user is accessed, the second information identifying an image-space distance in the image space corresponding to a real-world distance of interest in the real-world space. The real-world distance of interest is then estimated based on the second information and the determined transformation.

### CROSS-REFERENCES TO RELATED APPLICATIONS

The present application is a non-provisional patent application, claiming the benefit of priority of U.S. Provisional Application No. 61/586,228, filed on Jan. 13, 2012, entitled, “VIRTUAL RULER,” which is hereby incorporated by reference in its entirety.

### BACKGROUND

Frequently, it is important to identify accurate dimensions of objects in sight. For example, it may be necessary to identify an envelope's dimensions to determine postage, a picture's dimension to determine a frame size, dimensions of a desk to determine whether it will fit in a room, etc. While tape measures allow someone to measure these dimensions, a person may be without a tape measure at the time he wishes to obtain a measurement.

### SUMMARY

In some embodiments, methods and systems are provided for assisting a user in determining a real-world measurement. An imaging device (e.g., a camera within a cellular phone) may capture an image of a scene. A transformation (e.g., a homography) may be determined, which may account for one or more of: scaling, camera tilt, camera rotation, camera pan, camera position, etc. Determining the transformation may include locating a reference object (e.g., of a known size and/or shape) in the image of the scene, and comparing real-world spatial properties (e.g., dimensional properties) of the reference object to corresponding spatial properties (e.g., dimensional properties) in the image of the scene. A virtual ruler may be constructed based on the transformation and superimposed onto the image of the scene (e.g., presented on a display of the imaging device). A user may use the virtual ruler to identify real-world dimensions or distances in the scene. Additionally or alternatively, real-world measurement may be provided to a user in response to a request for a distance or dimension.

For example, a reference card may be placed on a surface in a scene. A camera in a mobile device may obtain an image of the scene and identify a transformation that would transform image-based coordinates associated with the reference card (e.g., at its corners) to coordinates having real-world meaning (e.g., such that distances between the transformed coordinates accurately reflect a dimension of the card). A user of the mobile device may identify a start point and a stop point within the imaged scene (e.g. by using a touchscreen to identify the points). Based on a transformation, the device may determine and display to the user a real-world distance between the start point and stop point along the plane of the reference card. In some embodiments, the entire process may be performed on a mobile device (e.g., a cellular phone).

In some embodiments, a method for estimating a real-world distance is provided. The method can include accessing first information indicative of an image of a scene and detecting one or more reference features associated with a reference object in the first information. The method can also include determining a transformation between an image space and a real-world space based on the image and accessing second information indicative of input from a user, the second information identifying an image-space distance in the image space corresponding to a real-world distance of interest in the real-world space. The method can further include estimating the real-world distance of interest based on the second information and the determined transformation.

In some embodiments, a system for estimating a real-world distance is provided. The system can include an imaging device for accessing first information indicative of an image of a scene and a reference-feature detector for detecting one or more reference features associated with a reference object in the first information. The system can also include a transformation identifier for determining a transformation between an image space and a real-world space based on the detected one or more reference features and a user input component for accessing second information indicative of input from a user of a mobile device that identifies an image-space distance in the image space corresponding to a real-world distance of interest in the real-world space. The system can further include a distance estimator for estimating the real-world distance of interest based on the second information and the determined transformation.

In some embodiments, a system for estimating a real-world distance is provided. The system can include means for accessing first information indicative of an image of a scene and means for detecting one or more reference features associated with a reference object in the image. The system can also include means for determining a transformation between an image space and a real-world space based on the first information and means for accessing second information indicative of input from a user, the second information identifying an image-space distance in the image space corresponding to a real-world distance of interest in the real-world space. The system can further include means for estimating the real-world distance of interest based on the second information and the determined transformation.

In some embodiments, a computer-readable medium is provided. The computer-readable medium can include a program which executes steps of accessing first information indicative of an image of a scene and detecting one or more reference features associated with a reference object in the image. The program can further execute steps of determining a transformation between an image space and a real-world space based on the first information and accessing second information indicative of input from a user, the second information identifying an image-space distance in the image space corresponding to a real-world distance of interest in the real-world space. The program can also execute a step of estimating the real-world distance of interest based on the second information and the determined transformation.

### BRIEF DESCRIPTION OF THE DRAWINGS

FIG. 1 illustrates a method for estimating a real-world distance based on an image according to an embodiment.

FIG. 2 shows an example of a mapping of image-based coordinates associated with reference features to a second space with real-world dimensions.

FIGS. 3A and 3B show examples of a system for identifying a real-world distance.

FIG. 4 shows a system for estimating a real-world distance according to an embodiment.

FIG. 5 shows a system for estimating a real-world distance according to an embodiment.

FIG. 6 illustrates an embodiment of a computer system.

### DETAILED DESCRIPTION

In some embodiments, methods and systems are provided for assisting a user in determining a real-world measurement. An imaging device (e.g., a camera within a cellular phone) may capture an image of a scene. A transformation (e.g., a homography) may be determined, which may account for one or more of: scaling, camera tilt, camera rotation, camera pan, camera position, etc. Determining the transformation may include locating a reference object (e.g., of a known size and/or shape) in the image of the scene, and comparing real-world spatial properties (e.g., dimensional properties) of the reference object to corresponding spatial properties (e.g., dimensional properties) in the image of the scene. A virtual ruler may be constructed based on the transformation and superimposed onto the image of the scene (e.g., presented on a display of the imaging device). A user may use the virtual ruler to identify real-world dimensions or distances in the scene. Additionally or alternatively, real-world measurement may be provided to a user in response to a request for a dimension or distance.

For example, a reference card may be placed on a surface in a scene. A camera in a mobile device may obtain an image of the scene and identify a transformation that would transform image-based coordinates associated with the reference card (e.g., at its corners) to coordinates having real-world meaning (e.g., such that distances between the transformed coordinates accurately reflect a dimension of the card). A user of the mobile device may identify a start point and a stop point within the imaged scene (e.g. by using a touchscreen to identify the points). Based on a transformation, the device may determine and display to the user a real-world distance between the start point and stop point along the plane of the reference card. In some embodiments, the entire process may be performed on a mobile device (e.g., a cellular phone).

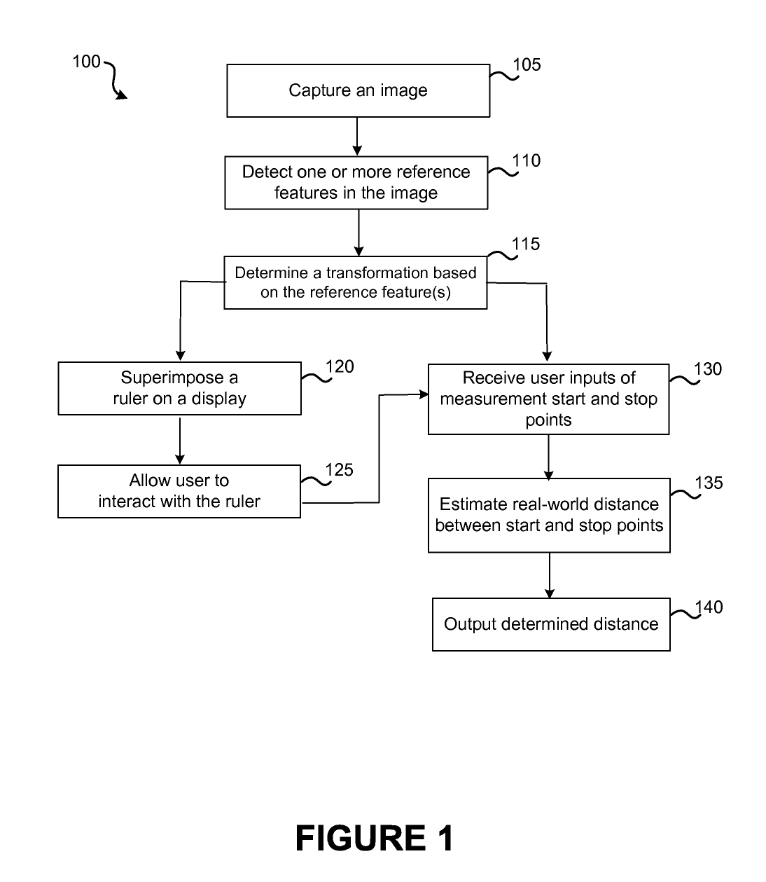

FIG. 1 illustrates a method 100 for estimating a real-world distance based on an image according to an embodiment. At 105, one or more images are captured. The images may be captured by an imaging device, such as a camera. The imaging device may be located within a portable and/or electronic device, such as a cellular phone, smart phone, personal digital assistant, tablet computer, laptop computer, digital watch, etc. The images may be individually and/or discretely captured. For example, a user may push a button or select an option to indicate a distinct point in time for the image to be captured. In one instance, images are repeatedly or continuously captured for a period of time. For example, a phone may image a scene through a lens and process and/or display real-time images or a subset of the real-time images.

At 110, one or more reference features in the image are detected or identified. In some instances two, three, four or more reference features are detected or identified. In one embodiment, the reference feature(s) are features of one or more reference object(s) known to be or suspected to be in the image. For example, a user may be instructed to position a particular object (such as a rectangular reference card) in a scene being imaged and/or on a plane of interest prior to capturing the image. As another example, a user may be instructed to position an object with one or more particular characteristic(s) (e.g., a credit card of standard dimension, a driver's license, a rectangular object, a quarter, a U.S.-currency bill, etc.) in the scene and/or on the plane. The object may be, e.g., rectangular, rigid, substantially planar, etc. The object may have: at least one flat surface; one, two or three dimensions less than six inches, etc. The object may have one or more distinguishing features (e.g., a visual distinguishing feature), such as a distinct visual pattern (e.g., a bar code, a series of colors, etc.). In some instances, the user is not instructed to put a reference object in the scene. For example, a technique may assume that at least one rectangular object is positioned within the scene and/or on a plane of interest.

One, more or all reference features may include, e.g., part of or an entire portion of an image corresponding to a reference object, edges, and/or corners. For example, reference features may include four edges defining a reference object. Reference features may include one or more portions of a reference object (e.g., red dots near a top of the reference object and blue dots near a bottom of the reference object).

Reference features may include positions (e.g., within an image-based two-dimensional coordinate system). For example, the image captured at 105 may include a two-dimensional representation of an imaged scene. The image may include a plurality of pixels, e.g., organized in rows and columns. Thus, image features may be identified as or based on pixel coordinates (e.g., corner 1 is located at (4, 16); corner 2 at (6,18), etc.).

Reference features may include one or more lengths and/or areas. The lengths and/or areas may have image-space spatial properties. For example, “Edge 1” could be 15.4 pixels long.

Reference features may be detected using one or more computer vision techniques. For example an edge-detection algorithm may be used, spatial contrasts at various image locations may be analyzed, a scale-invariant feature transform may be used, etc.

Reference features may be detected based on user inputs. For example, a user may be instructed to identify a location of the reference features. The user may, e.g., use a touch screen, mouse, keypad, etc. to identify positions on an image corresponding to the reference features. In one instance, the user is presented with the image via a touch-screen electronic display and is instructed to touch the screen at four locations corresponding to corners of the reference object.

One, two, three, four or more reference feature(s) may be detected. In one embodiment, at least four reference features are detected, at least some or all of the reference features having a fixed and known real-world distance between each other. For example, four corners of a credit-card reference object may be detected. In one embodiment, at least four reference features are detected, at least some or all of the reference features having a fixed and known real-world spatial property (e.g., real-world dimension) associated with the feature itself. For example, four edges of a credit-card reference object may be detected.

At 115, a transformation may be determined based on one or more spatial properties associated with the reference feature(s) detected in the image and/or one or more corresponding real-world spatial properties. The transformation may include a magnification, a rotational transformation, a translational transformation and/or a lens distortion correction. The transformation may include a homography and/or may mitigate or at least partly account for any perspective distortion. The transformation may include intrinsic parameters (e.g., accounting for parameters, such as focal length) that are intrinsic to an imagine device and/or extrinsic parameters (e.g., accounting for a camera angle or position) that depend on the scene being imaged. The transformation may include a camera matrix, a rotation matrix, a translation matrix, and/or a joint rotation-translation matrix.

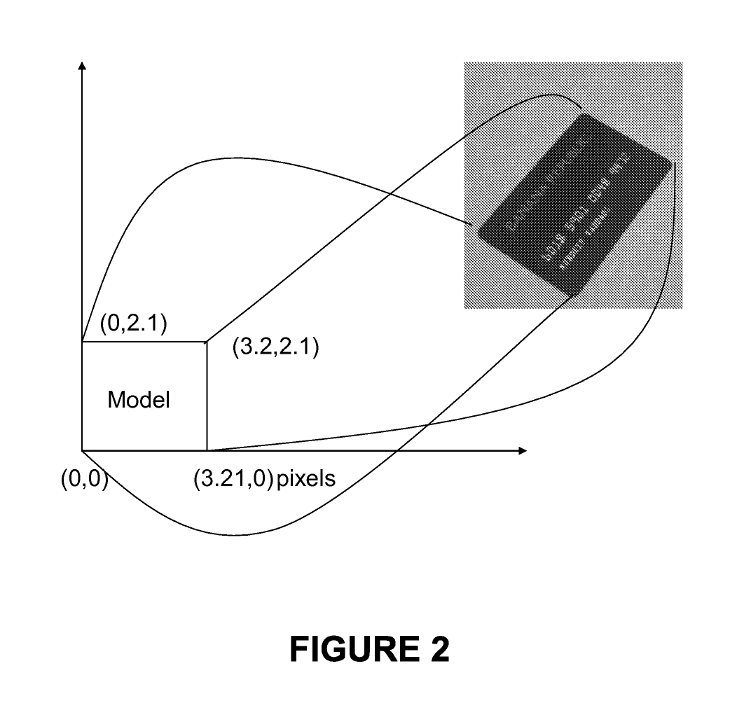

The transformation may comprise a transformation between an image space (e.g., a two-dimensional coordinate space associated with an image) and a real-world space (e.g., a two- or three-dimensional coordinate space identifying real-world distances, areas, etc.). The transformation may be determined by determining a transformation that would convert an image-based spatial property (e.g., coordinate, distance, shape, etc.) associated with one or more reference feature(s) into another space (e.g., being associated with real-world distances between features). For example, image-based positions of four corners of a specific rectangular reference object may be detected at 110 in method 100. Due to a position, rotation and/or tilt of an imaging device used to capture the image, the object may appear to be tilted and/or non-rectangular (e.g., instead appearing as a trapezoid). The difference in shapes between spatial properties based on the image and corresponding real-life spatial properties (e.g., each associated with one or more reference features) may be at least partly due to perspective distortion (e.g., based on an imaging device's angle, position and/or focal length). The transformation may be determined to correct for the perspective distortion. For example, reference features may include edges of a rectangular reference-object card. The edges may be associated with image-based spatial properties, such that the combination of image-based edges for a trapezoid. Transforming the image-based spatial properties may produce transformed edges that form a rectangle (e.g., of a size corresponding to a real-world size of the reference-object card). For example, image-based dimensions of corner 1 may map to transformed coordinates (0,0); dimensions of corner 2 to coordinates (3.21, 0); etc.). See FIG. 2.

Eqns. 1-3 show an example of how two-dimensional image-based coordinates (p, q) may be transformed into a two-dimensional real-world coordinates (x, y). In Eqn. 1, image-based coordinates (p, q) are transformed using rotation-related variables (r₁₁-r₃₂), translation-related variables (tₓ-t_{z}), and camera-based or perspective-projection variables (f). Eqn. 2 is a simplified version of Eqn. 1, and Eqn. 3 combines variables into new homography variables (h₁₁-h₃₃).

$$\begin{matrix}[ \begin{matrix}x \\ y \\ 1\end{matrix} ] \sim [ \begin{matrix}f & 0 & 0 \\ 0 & f & 0 \\ 0 & 0 & 1\end{matrix} ] [ \begin{matrix}{r}_{11} & {r}_{12} & {t}_{x} \\ {r}_{21} & {r}_{22} & {t}_{y} \\ {r}_{31} & {r}_{32} & {t}_{z}\end{matrix} ] [ \begin{matrix}p \\ q \\ 1\end{matrix} ] & Eqn . 1 \\ [ \begin{matrix}x \\ y \\ 1\end{matrix} ] \sim [ \begin{matrix}{fr}_{11} & {fr}_{12} & f {t}_{x} \\ {fr}_{21} & {fr}_{22} & f {t}_{y} \\ {r}_{31} & {r}_{32} & {t}_{z}\end{matrix} ] [ \begin{matrix}p \\ q \\ 1\end{matrix} ] & Eqn . 2 \\ [ \begin{matrix}x \\ y \\ 1\end{matrix} ] \sim [ \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ] [ \begin{matrix}p \\ q \\ 1\end{matrix} ] & Eqn . 3\end{matrix}$$

Multiple image points may be transformed in this manner. Distances between the transformed points may correspond to actual real-world distances, as explained in greater detail below.

Reference feature(s) detected at 110 in method 100 may be used to determine the homography variables in Eqn. 3. In some instances, an image is or one or more reference features (e.g., corresponding to one or more image-based coordinates) are first preconditioned. For example, a pre-conditioning translation may be identified (e.g., as one that would cause an image's centroid to be translated to an origin coordinate), and/or a pre-conditioning scaling factor may be identified (e.g., such that an average distance between an image's coordinates and the centroid is the square root of two). One or more image-based spatial properties (e.g., coordinates) associated with the detected reference feature(s) may then be preconditioned by applying the pre-conditioning translation and/or pre-conditioning scaling factor.

In some embodiments, homography variable h₃₃ may be set to 1 or the sum of the squares of the homography variables may be set to 1. Other homography variables may then be identified by solving Eqn. 3 (using coordinates associated with the reference feature(s)). For example, Eqn. 4 shows how Eqn. 3 may be applied to each of four real-world points (x₁, y₁) through (x₄, y₄) and four image-based points (x′₁, y′₁) through (x′₄, y′₄) and then combined as a single equation.

$$[ \begin{matrix}{x}_{1} & {y}_{1} & 1 & 0 & 0 & 0 & - {x}_{1} {x}_{1}^{′} & - {y}_{1} {x}_{1}^{′} \\ 0 & 0 & 0 & {x}_{1} & {y}_{1} & 1 & - {x}_{1} {y}_{1}^{′} & - {y}_{1} {y}_{1}^{′} \\ {x}_{2} & {y}_{2} & 1 & 0 & 0 & 0 & - {x}_{2} {x}_{2}^{′} & - {y}_{2} {x}_{2}^{′} \\ 0 & 0 & 0 & {x}_{2} & {y}_{2} & 1 & - {x}_{2} {y}_{2}^{′} & {y}_{2} {y}_{2}^{′} \\ {x}_{3} & {y}_{3} & 1 & 0 & 0 & 0 & - {x}_{3} {x}_{3}^{′} & - {y}_{3} {x}_{3}^{′} \\ 0 & 0 & 0 & {x}_{3} & {y}_{3} & 1 & - {x}_{3} {y}_{3}^{′} & - {y}_{3} {y}_{3}^{′} \\ {x}_{4} & {y}_{4} & 1 & 0 & 0 & 0 & - {x}_{4} {x}_{4}^{′} & - {y}_{4} {x}_{4}^{′} \\ 0 & 0 & 0 & {x}_{4} & {y}_{4} & 1 & - {x}_{4} {y}_{4}^{′} & - {y}_{4} {y}_{4}^{′}\end{matrix} ] [ \begin{matrix}{h}_{11} \\ {h}_{12} \\ {h}_{13} \\ {h}_{21} \\ {h}_{22} \\ {h}_{23} \\ {h}_{31} \\ {h}_{32}\end{matrix} ] = [ \begin{matrix}{x}_{1}^{′} \\ {y}_{1}^{′} \\ {x}_{2}^{′} \\ {y}_{2}^{′} \\ {x}_{3}^{′} \\ {y}_{3}^{′} \\ {x}_{4}^{′} \\ {y}_{4}^{′}\end{matrix} ] \qquad Eqn . 4$$

In a simplified matrix form, Eqn. 4 may be represented as:

A*H=X Eqn. 5:

Eqn. 5 may be solved by a linear system solver or as H=(A^{T}A)⁻¹(A^{T}X). If the sum of the squares of the homography variables are set to one, Eqn. 5 may be, e.g., solved using singular-value decomposition.

As further detailed below, input may be received from a user identifying a distance of interest. The input may be obtained an image space. For example, a user may use an input component (e.g., a touchscreen, mouse, etc.) to identify endpoints of interest in a captured and/or displayed image. As another example, a user may rotate a virtual ruler such that the user may identify a distance of interest along a particular direction. The distance may be estimated. In some instances, estimation of the distance amounts to an express and specific estimation of a particularly identified distance. For example, a user may indicate that a distance of interest is the distance between two endpoints, and the distance may thereafter be estimated and presented. In some instances, estimation of the distance is less explicit. For example, a virtual ruler may be generated or re-generated after a user identifies an orientation of the ruler. A user may then be able to identify a particular distance using, e.g., markings on a presented virtual ruler. In method 100, 120-125 exemplify one type of distance estimation based on user input (e.g., generation of an interactive virtual ruler), and 130-140 exemplify another type of distance estimation based on user input (e.g., estimated a real-world distance between user-input start and stop points). These examples are illustrative. Other types of user inputs and estimations may be performed. In some instances, only one of 120-125 and 130-140 are performed.

At 120-140 of method 100, the transformation may be used to estimate and present to a user a correspondence between a distance in the image and a real-world distance. For example, this indication may include applying the transformation to image-based coordinates and/or distances (e.g., to estimate a distance between two user-identified points) and/or applying an inverse of the transformation (e.g., to allow a user to view a scaling bar presented along with the most or all of the image).

At 120, a ruler may be superimposed on a display. The ruler may identify a real-world distance corresponding to a distance in the captured image. For example, the ruler may identify a real-world distance corresponding to a distance along a plane of a surface of a reference object. The correspondence may be identified based on the transformation identified at 115. For example, an inverse of an identified homography or transformation matrix may be applied to real-world coordinates corresponding to measurement markers of a ruler.

The ruler may include one or more lines and/or one or more markings (e.g., tick marks). Distances between one or more markings may be identified as corresponding to a real-world distance. For example, text may be present on the ruler (e.g., “1”, “2”, “1 cm”, “in”, etc.). As another example, a user may be informed that a distance between tick marks corresponds to a particular unit measure (e.g., an inch, centimeter, foot, etc.). The information may be textually presented on a display, presented as a scale bar, included as a setting, etc.

Distances between each pair of adjacent tick marks may be explicitly or implicitly identified as corresponding to a fixed real-world distance (e.g., such that distances between each pair of adjacent tick marks corresponds to one real-world inch, even though absolute image-based distances between the marks may differ depending upon the position along the ruler). In some instances, a real-world distance associated with image-based inter-mark distances may be determined based on a size of an imaged scene. (For example, a standard SI unit may be used across all scenes, but the particular unit may be a smaller unit, such as a centimeter for smaller imaged scenes and a larger unit, such as a meter, for larger imaged scenes.) In some instances, a user can set the real-world distance associated with inter-mark image-based distances.

The ruler may extend across part or all of a display screen (e.g., on a mobile device or imaging device). In one instance, the ruler's length is determined based on a real-world distance (e.g., such that a corresponding real-world distance of the ruler is 1 inch, 1 foot, 1 yard, 1 meter, 1 kilometer, etc.). The ruler may or may not be partly transparent. The ruler may or may not appear as a traditional ruler. In some embodiments, the ruler may appear as a series of dots, a series of ticks, one or more scale bars, a tape measure, etc. In some instances (but not others), at least part of the image of the scene is obscured or not visible due to the presence of the ruler.

At 125, a user may be allowed to interact with the ruler. For example, the user may be able to expand or contract the ruler. For example, a ruler corresponding to 12 real-world inches may be expanded into a ruler corresponding to 14 real-world inches. The user may be able to move a ruler, e.g., by moving the entire ruler horizontally or vertically or rotating the ruler. In some embodiments, a user may interact with the ruler by dragging an end or center of the ruler to a new location. In some embodiments, a user may interact with the ruler through settings (e.g., to re-locate the ruler, set measurement units, set ruler length, set display characteristics, etc.).

In some embodiments, inter-tick image-based distances change after the interaction. For example, if a user rotates a ruler from a vertical orientation to a horizontal orientation, the rotation may cause distances between tick marks to be more uniform (e.g., as a camera tilt may require more uneven spacing for the vertically oriented ruler). In some embodiments, inter-tick real-world-based distances change after the interaction. For example, a “1 inch” inter-tick real-world distance may correspond to a 1 cm image-based inter-tick distance when a ruler is horizontally oriented but to a 0.1 cm image-based inter-tick distance when the ruler is vertically oriented. Thus, upon a horizontal-to-vertical rotation, the scaling on the ruler may be automatically varied to allow a user to more easily estimate dimensions or distances using the ruler.

At 130 in method 100, user inputs of measurement points or endpoints may be received. For example, a user may identify an image-based start point and an image-based stop point (e.g., by touching a display screen at the start and stop points, clicking on the start and stop points, or otherwise identifying the points). In some embodiments, each of these points correspond to coordinates in an image space.

At 135, a real-world distance may be estimated based on the user measurement-point inputs. For example, user input may include start and stop points, each associated with two-dimensional image-space coordinates. The transformation determined at 115 may be applied to each point. The distance between the transformed points may then be estimated. This distance may be an estimate of a real-world distance between the two points when each point is assumed to be along a plane of a surface of a reference object.

At 140, the estimated distance is output. For example, the distance may be presented or displayed to the user (e.g., nearly immediately) after the start and stop points are identified.

In some embodiments, method 100 does not include 120-125 and/or does not include 130-140. Other variations are also contemplated.

The transformations determined at 115 may be applied to other applications not shown in FIG. 1. For example, a real-world distance (e.g., of an empty floor space) may be calculated, and a user may be informed as to whether an imaged setting could be augmented to include another object. As one specific example, an image of a living room may be captured. A reference object may be placed on a floor of the room, a transformation may be determined, and a distance of an empty space against a wall be identified. An image of a couch (in a store) may be captured. A reference object may be placed on a floor, another transformation may be determined, and a floor dimension of the chair may be determined. It may then be determined whether the chair would fit in the empty space in the living room. In some instances, an augmented setting may be displayed when the object would fit.

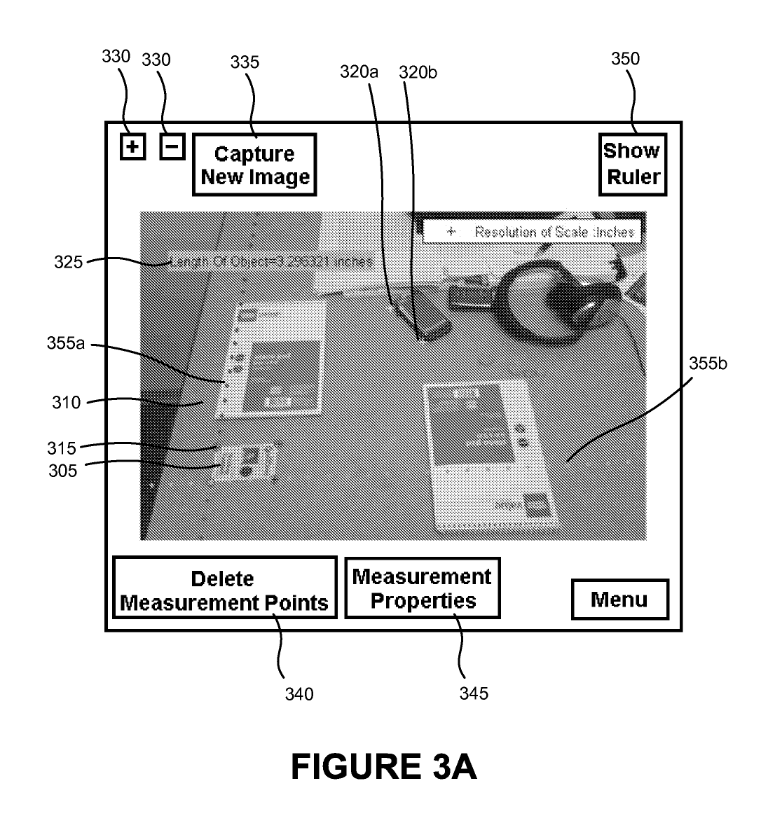

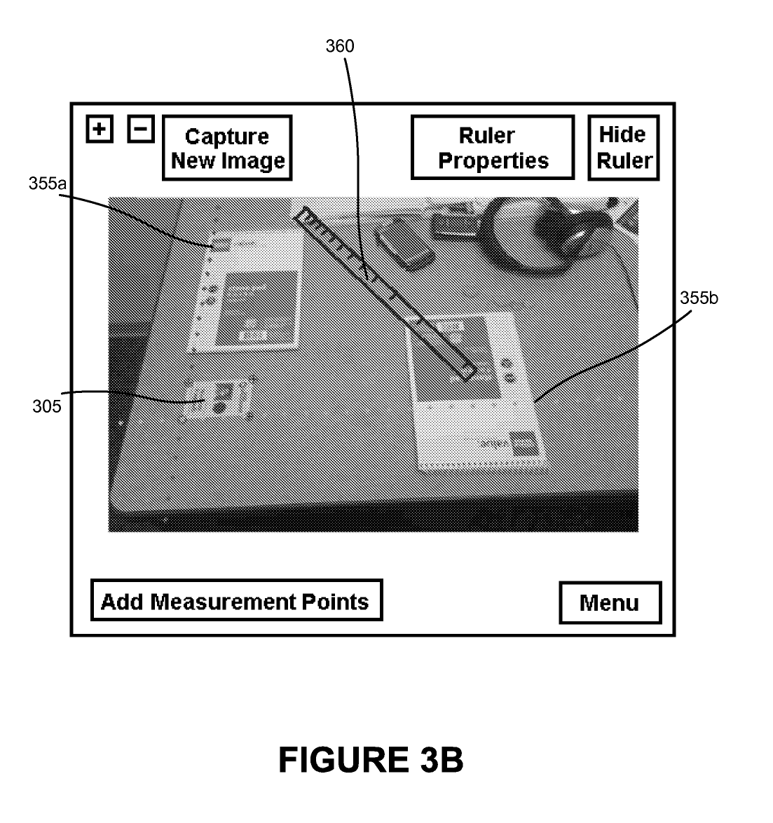

FIG. 3A shows an example of a system for estimating a real-world distance. In this embodiment, a reference object includes a card 305. The reference object is placed on a table 310. Corners 315 of the card are detected as reference features. Thus, each of the corners may be detected and associated with image-based coordinates. Using these coordinates and known spatial properties of the card (e.g., dimensions), a transformation may be determined A user may then identify start and stop points 320a and 320b by touching the display screen. Cursor markers are thereafter displayed at these locations. Using the determined transformation, a real-world distance between the start and stop points may be estimated. This estimate may be based on an assumption that the two points are along a plane of a surface of the card. The screen includes a distance display 325, informing a user of the determined real-world distance. As shown, the distance display 325 may include a numerical estimate of the distance (“3.296321”), a description of what is being presented (“Length of Object”) and/or units (“inches”).

FIG. 3A also shows a number of other options available to a user. For example, a user may be able to zoom in or out of the image, e.g., using zoom features 330. A transformation may be recalculated after the zoom or the transformation may be adjusted based on a known magnification scale effected by the zoom. In one embodiment, a user may actively indicate when a new image is to be captured (e.g., by selecting a capture image option 335). In some embodiments, images are continuously or regularly captured during some time period (e.g., while a program is operating).

A user may modify measurement points (e.g., stop and start points), e.g., by dragging and dropping each point to a new location or deleting the points (e.g., using a delete points option 340) and creating new ones. A user may be allowed to set measurement properties (e.g., using a measurement-properties feature 345). For example, a user may be able to identify units of measure, confidence metrics shown, etc. A user may also be able to show or hide a ruler (e.g., using a ruler display option 350).

FIG. 3B shows an example of a system for estimating a real-world distance. This embodiment is similar to the embodiment shown in FIG. 3A. One distinction is that an additional ruler 360 is shown. FIG. 3B emphasizes the different types of rulers that may be displayed. In one embodiment, a ruler may consist of a series of markings extending along an invisible line. For example, in FIGS. 3A and 3B, each distance between adjacent dots in either of rulers 355a or 355b may correspond to a fixed real-world distance (e.g., of one inch). The ruler may or may not extend an entire image. FIGS. 3A and 3B show examples of two invisible-line rulers 355a and 355b. In this embodiment, the rulers are initially positioned along borders of reference card 305, such that the two rulers 355a and 355b represent directions that correspond to perpendicular real-world directions. A ruler's initial position may be a position that is: bordering a reference object, parallel to an image edge, perpendicular in real-space to another ruler, perpendicular in image-space to another ruler, intersecting with a center of an image, etc.

FIG. 3B shows another ruler 360. This ruler's appearance is similar to a traditional ruler. Ruler 360 may be transparent, such that a user may view an underlying image. Ruler 360 may again have a series of markings, and distances between adjacent markings may correspond to a fixed real-world distance (e.g., one inch). Though not shown, a ruler may include numbers (e.g., associated with one, more or all markings) and or text (e.g., indicating units of measure). The markings of ruler 360 are not to scale but are shown to emphasize the fact that often, identifying real-world distances associated with images distances is more complicated than identifying a single scaling factor. For example, an imaging device may be tilted with respect to a plane of interest. Thus, if markings are displayed in a manner to indicate that distances between adjacent markings corresponds to a fixed real-world distance, the image-based distances between markings may change along a length of the ruler.

In some instances, only one type of ruler (e.g., similar to ruler 355 or similar to ruler 360) is presented. In some instances, multiple rulers (of a same or different type are presented. For example, in FIG. 3B two rulers 355 are shown. This may allow a user to simultaneously estimate dimensions or distances along multiple directions. In some instances, multiple rulers are presented in a manner such that a real-world angle associated with an image-based angle separating the rulers at their intersection is fixed. For example, the rulers may be presented such that they are always identifying estimated distances along directions perpendicular in the real world.

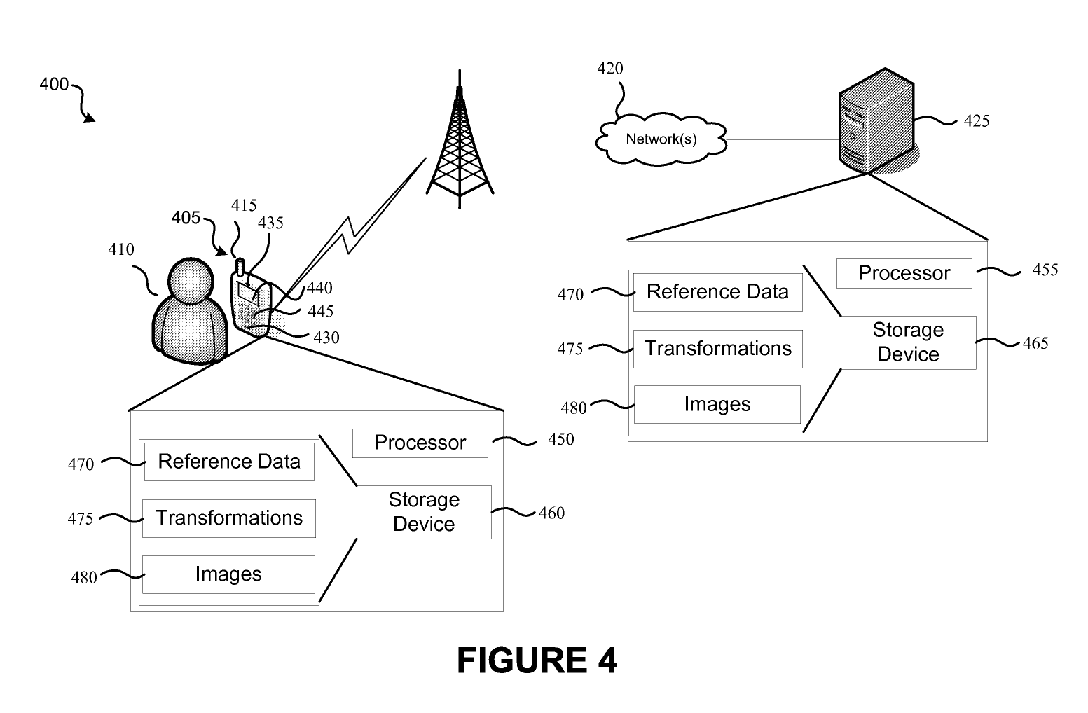

FIG. 4 shows a system 400 for estimating a real-world distance according to an embodiment. The system may include a device, which may be an electronic device, portable device and/or mobile device (e.g., a cellular phone, smart phone, personal digital assistant, tablet computer, laptop computer, digital camera, handheld gaming device, etc.). As shown, system 400 includes a device 405 (e.g., a mobile device or cellular phone) that may be used by a user 410. Device 405 may include a transceiver 415, which may allow the device to send and/or receive data and/or voice communications. Device 405 may be connected (e.g., via transceiver 415) to a network 420 (e.g., a wireless network and/or the Internet). Through the wireless network, device 405 may be able to communicate with an external server 425.

Device 405 may include a microphone 430. Microphone 430 may permit device 405 to collect or capture audio data from the device's surrounding physical environment. Device 405 may include a speaker 435 to emit audio data (e.g., received from a user on another device during a call, or generated by the device to instruct or inform the user 410). Device 405 may include a display 440. Display 440 may include a display, such as one shown in FIGS. 3A-3B. Display 440 may present user 410 with real-time or non-real-time images and inform a user of a real-world distance associated with a distance along the image (e.g., by displaying a determined distance based on user-input endpoints or superimposing a ruler on the image). Display 440 may present interaction options to user 410 (e.g., to allow user 410 to capture an image, view a superimposed real-world-distance ruler on the image, move the ruler, identify measurement endpoints in the image, etc.). Device 405 may include user-input components 445. User-input components 445 may include, e.g., buttons, a keyboard, a number pad, a touch screen, a mouse, etc. User-input components 445 may allow, e.g., user 410 to move a ruler, modify a setting (e.g., a ruler or measurement setting), identify measurement endpoints, capture a new image, etc.). Though not shown, device 405 may also include an imaging component (e.g., a camera). The imaging component may include, e.g., a lens, light source, etc.

Device 405 may include a processor 450, and/or device 405 may be coupled to an external server 425 with a processor 455. Processor(s) 450 and/or 455 may perform part or all of any above-described processes. In some instances, identification and/or application of a transformation (e.g., to determine real-world distances) is performed locally on the device 405. In some instances, external server's processor 455 is not involved in determining and/or applying a transformation. In some instances, both processors 450 and 455 are involved.

Device 405 may include a storage device 460, and/or device 405 may be coupled to an external server 425 with a storage device 465. Storage device(s) 460 and/or 465 may store, e.g., images, reference data (e.g., reference features and/or reference-object dimensions), camera settings, and/or transformations. For example, images may captured and stored in an image database 480. Reference data indicating reference features to be detected in an image and real-world distance data related to the features (e.g., distance separation) may be stored in a reference database 470. Using the reference data and an image, a processor 450 and/or 455 may determine a transformation, which may then be stored in a transformation database 475. Using the transformation, a virtual ruler may be superimposed on an image and displayed to user 410 and/or real-world distances corresponding to (e.g., user-defined) image distances may be determined (e.g., by processor 450 and/or 455).

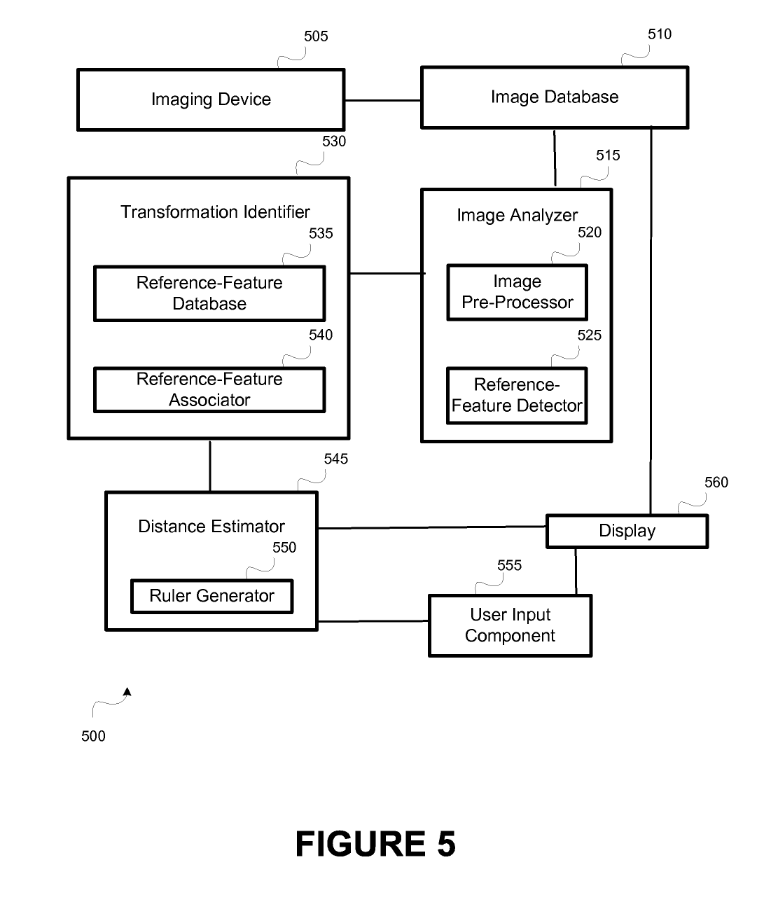

FIG. 5 shows a system 500 for estimating a real-world distance according to an embodiment. All or part of system 500 may be included in a device, such as an electronic device, portable device and/or mobile device. In some instances, part of system 500 is included in a remote server.

System 500 includes an imaging device 505. Imaging device 505 may include, e.g., a camera. Imaging device 505 may be configured to visually image a scene and thereby obtain images. Thus, for example, the imaging device 505 may include a lens, light, etc.

One or more images obtained by imaging device 505 may be stored in an image database 510. For example, images captured by imaging device 505 may include digital images, and electronic information corresponding to the digital images and/or the digital images themselves may be stored in image database 510. Images may be stored for a fixed period of time, until user deletion, until imaging device 505 captures another image, etc.

A capture image may be analyzed by an image analyzer 515. Image analyzer 515 may include an image pre-processor 520. Image pre-processor 520 may, e.g., adjust contrast, brightness, color distributions, etc. of the image. The pre-processed image may be analyzed by reference-feature detector 525. Reference-feature detector 525 may include, e.g., an edge detector or contrast analyzer. Reference-feature detector 525 may attempt to detect edges, corners, particular patterns, etc. Particularly, reference-feature detector 525 may attempt to a reference object in the image or one or more parts of the reference objects. In some embodiments, reference-feature detector 525 comprises a user-input analyzer. For example, the reference-feature detector 525 may identify that a user has been instructed to use an input device (e.g., a touch screen) to identify image locations of reference features, to receive the input, and to perform any requisite transformations to transform the image into the desired units and format. The reference-feature detector may output one or more image-based spatial properties (e.g., coordinates, lengths, shapes, etc.).

The one or more image-based spatial properties may be analyzed by transformation identifier 530. Transformation identifier 530 may include a reference-feature database 535. The reference-feature database 535 may include real-world spatial properties associated with a reference object. Transformation identifier 530 may include a reference-feature associator 540 that associates one or more image-based spatial-properties (output by reference-feature detector 525) with one or more real-world-based spatial-properties (identified from reference-feature database 535). In some instances, the precise correspondence of features is not essential. For example, if the reference features correspond to four edges of a rectangular card, it may be sufficient to recognize which of the image-based edges correspond to a real-world-based “long” edge (and not essential to distinguish one long edge from the other). Using the image-based spatial properties and associated real-world-based spatial properties, transformation identifier 530 may determine a transformation (e.g., a homography).

The transformation may be used by a ruler generator 545 to generate a ruler, such as a ruler described herein. The generated ruler may identify real-world distances corresponding to distances within an image (e.g., along a plane of a surface of a reference object). The ruler may be displayed on a display 550. The display 550 may further display the captured image initially captured by imaging device 505 and stored in image database 510. In some instances, display 550 displays a current image (e.g., not one used during the identification of the transformation or detection of reference features). (Transformations may be held fixed or adjusted, e.g., based on detected device movement.) The ruler may be superimposed on the displayed image. User input may be received via a user input component 555, such that a user can interact with the generated ruler. For example, a user may be able to rotate the ruler, expand the ruler, etc. User input component 555 may or may not be integrated with the display (e.g., as a touchscreen).

In some instances, a distance estimator 560 may estimate a real-world distance associated with an image-based distance. For example, a user may identify a start point and a stop point in a displayed image (via user input component). Using the transformation identified by transformation identifier 530, an estimated real-world distance between these points (along a plane of a surface of a reference object) may be estimated. The estimated distance may be displayed on display 550.

In some instances, imaging device 505 repeatedly captures images, image analyzer repeatedly analyzes images, and transformation identifier repeatedly identifies transformations. Thus, real-time or near-real-time images may be displayed on display 550, and a superimposed ruler or estimated distance may remain rather accurate based on the frequently updated transformations.

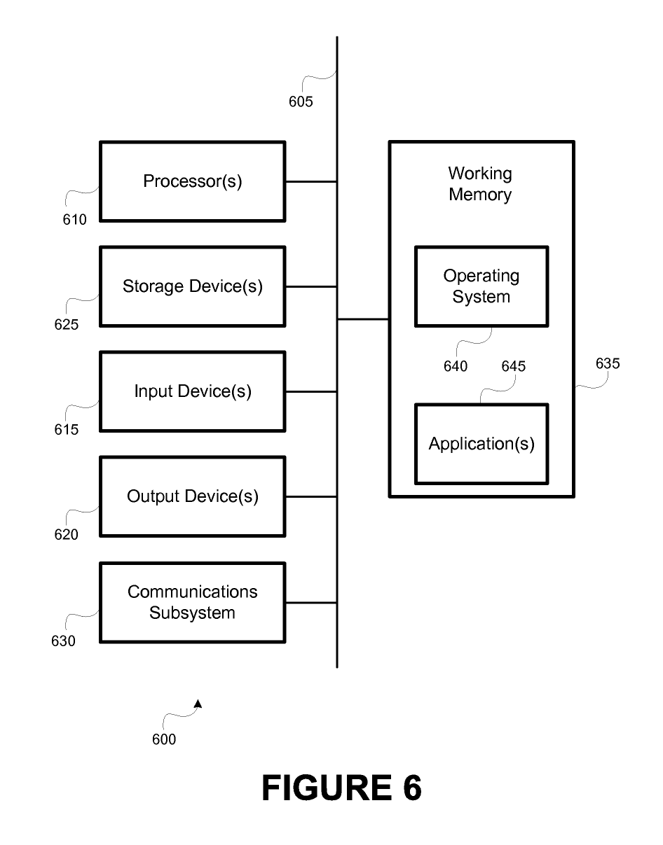

A computer system as illustrated in FIG. 6 may be incorporated as part of the previously described computerized devices. For example, computer system 600 can represent some of the components of the mobile devices and/or the remote computer systems discussed in this application. FIG. 6 provides a schematic illustration of one embodiment of a computer system 600 that can perform the methods provided by various other embodiments, as described herein, and/or can function as the external server 425 and/or device 405. It should be noted that FIG. 6 is meant only to provide a generalized illustration of various components, any or all of which may be utilized as appropriate. FIG. 6, therefore, broadly illustrates how individual system elements may be implemented in a relatively separated or relatively more integrated manner.

The computer system 600 is shown comprising hardware elements that can be electrically coupled via a bus 605 (or may otherwise be in communication, as appropriate). The hardware elements may include one or more processors 610, including without limitation one or more general-purpose processors and/or one or more special-purpose processors (such as digital signal processing chips, graphics acceleration processors, and/or the like); one or more input devices 615, which can include without limitation a mouse, a keyboard and/or the like; and one or more output devices 620, which can include without limitation a display device, a printer and/or the like.

The computer system 600 may further include (and/or be in communication with) one or more storage devices 625, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 600 might also include a communications subsystem 630, which can include without limitation a modem, a network card (wireless or wired), an infrared communication device, a wireless communication device and/or chipset (such as a Bluetooth™ device, an 802.11 device, a WiFi device, a WiMax device, cellular communication facilities, etc.), and/or the like. The communications subsystem 630 may permit data to be exchanged with a network (such as the network described below, to name one example), other computer systems, and/or any other devices described herein. In many embodiments, the computer system 600 will further comprise a working memory 635, which can include a RAM or ROM device, as described above.

The computer system 600 also can comprise software elements, shown as being currently located within the working memory 635, including an operating system 640, device drivers, executable libraries, and/or other code, such as one or more application programs 645, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 625 described above. In some cases, the storage medium might be incorporated within a computer system, such as the system 600. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 600 and/or might take the form of source and/or installable code, which, upon compilation and/or installation on the computer system 600 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 600) to perform methods in accordance with various embodiments. According to a set of embodiments, some or all of the procedures of such methods are performed by the computer system 600 in response to processor 610 executing one or more sequences of one or more instructions (which might be incorporated into the operating system 640 and/or other code, such as an application program 645) contained in the working memory 635. Such instructions may be read into the working memory 635 from another computer-readable medium, such as one or more of the storage device(s) 625. Merely by way of example, execution of the sequences of instructions contained in the working memory 635 might cause the processor(s) 610 to perform one or more procedures of the methods described herein.

The terms “machine-readable medium” and “computer-readable medium,” as used herein, refer to any medium that participates in providing data that causes a machine to operate in a specific fashion. Computer readable medium and storage medium do not refer to transitory propagating signals. In an embodiment implemented using the computer system 600, various computer-readable media might be involved in providing instructions/code to processor(s) 610 for execution and/or might be used to store such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 625. Volatile media include, without limitation, dynamic memory, such as the working memory 635.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, etc.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application. Also, a number of steps may be undertaken before, during, or after the above elements are considered. Accordingly, the above description does not bound the scope of the claims.

What is claimed is:

1. A method for estimating a real-world distance, the method comprising:
accessing first information indicative of an image of a scene;
detecting one or more reference features associated with a reference object in the first information;
determining a transformation between an image space and a real-world space based on the image;
accessing second information indicative of input from a user, the second information identifying an image-space distance in the image space corresponding to a real-world distance of interest in the real-world space; and
estimating the real-world distance of interest based on the second information and the determined transformation.

2. The method of claim 1, wherein the second information comprises a start point and an endpoint, and the real-world distance of interest comprises a distance between real-world locations associated with the start point and the endpoint.

3. The method of claim 1, further comprising superimposing a virtual ruler on the image.

4. The method of claim 3, wherein the second information comprises a position where at least part of the superimposed virtual ruler is to be located on the image.

5. The method of claim 1, wherein the transformation at least partly accounts for perspective distortion.

6. The method of claim 1, wherein the transformation comprises a homography matrix.

7. The method of claim 1, wherein the method is performed in its entirety on a mobile device.

8. The method of claim 7, wherein the mobile device comprises a cellular phone.

9. The method of claim 1, wherein the reference object comprises a substantially flat and substantially rectangular object.

10. The method of claim 1, further comprising:
determining at least one first spatial property in the image space associated with the one or more of the reference features;
determining at least one second spatial property in the real-world space associated with the one or more of the reference features; and
determining the transformation based on the at least one first spatial property and the at least one second spatial property.

11. The method of claim 1, wherein both the estimated real-world distance of interest and a surface of the reference object lie along a same plane.

12. The method of claim 1, wherein estimating the real-world distance of interest comprises applying an inverse of the transformation.

13. A system for estimating a real-world distance, the system comprising:
an imaging device for accessing first information indicative of an image of a scene;
a reference-feature detector for detecting one or more reference features associated with a reference object in the first information;
a transformation identifier for determining a transformation between an image space and a real-world space based on the detected one or more reference features;
a user input component for accessing second information indicative of input from a user of a mobile device that identifies an image-space distance in the image space corresponding to a real-world distance of interest in the real-world space; and
a distance estimator for estimating the real-world distance of interest based on the second information and the determined transformation.

14. The system of claim 13, wherein the second information comprises a rotation of a ruler superimposed on a presentation of the image.

15. The system of claim 13, wherein the distance estimator comprises a ruler generator for generating a virtual ruler to be presented by a display.

16. The system of claim 13, wherein a display simultaneously presents the estimated real-world distance of interest and the image.

17. The system of claim 13, wherein the reference-feature detector comprises an edge detector.

18. The system of claim 13, wherein the user input component and the display are integrated as a touchscreen display.

19. A system for estimating a real-world distance, the system comprising:
means for accessing first information indicative of an image of a scene;
means for detecting one or more reference features associated with a reference object in the image;
means for determining a transformation between an image space and a real-world space based on the first information;
means for accessing second information indicative of input from a user, the second information identifying an image-space distance in the image space corresponding to a real-world distance of interest in the real-world space; and
means for estimating the real-world distance of interest based on the second information and the determined transformation.

20. The system of claim 19, wherein the means for accessing the first information comprise a camera in a mobile phone.

21. The system of claim 19, wherein the means for detecting the one or more reference features comprise an edge detector.

22. The system of claim 19, wherein the means for accessing the second information indicative of the input from the user comprise a touchscreen display.

23. The system of claim 19, wherein the means for estimating the real-world distance of interest comprise a ruler generator.

24. The system of claim 19, further comprising means for presenting the estimated real-world distance of interest.

25. A computer-readable medium containing a program which executes steps of:
accessing first information indicative of an image of a scene;
detecting one or more reference features associated with a reference object in the image;
determining a transformation between an image space and a real-world space based on the first information;
accessing second information indicative of input from a user, the second information identifying an image-space distance in the image space corresponding to a real-world distance of interest in the real-world space; and
estimating the real-world distance of interest based on the second information and the determined transformation.

26. The computer-readable medium of claim 25, wherein the program further executes a step of:
identifying real-world spatial properties associated with the reference object from a database.

27. The computer-readable medium of claim 25, wherein the transformation comprises a homography.

28. The computer-readable medium of claim 25, wherein the second information comprises a start point and a stop point.
